(19) United States
(12) Patent Application Publication
(10) Pub. No.: US 2003/0113617 A1
(43) Pub. Date: Jun. 19, 2003

(54) Storage cell module

(75) Inventors: Laurent Gaignerot, Pessac (FR); Gerard Rigobert, Fargues St Hilaire (FR); Philippe Jonac, Gradignan (FR)

Correspondence Address: SUGHRUE MION, PLLC, Suite 800, 2100 Pennsylvania Avenue, Washington, DC, 20037-3213, US

(73) Assignee: ALCATEL

(21) Appl. No.: 10/062,547

(22) Filed: Feb. 5, 2002

(30) Foreign Application Priority Data
Dec. 13, 2001 (FR) 01 16 110

(51) Int. Cl. H01M 2/10

(52) U.S. Cl. 429/99; 429/62; 429/156; 29/623.1

(57) ABSTRACT

A module including at least two storage cells in a common envelope including a bottom including at least two openings with dimensions at least equal to the size of the storage cells and means for fixing the storage cells in the openings, an intermediate body including housings to receive the storage cells, a plate for electrically connecting the storage cells, and a protective cover.

### CROSS-REFERENCE TO RELATED APPLICATIONS

This application is based on French Patent Application No. 01 16 110 filed Dec. 13, 2001, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to a module consisting of at least two juxtaposed storage cells in a casing. The storage cells can be primary or secondary, aqueous electrolyte or non-aqueous electrolyte storage cells. For example, they can be alkaline electrolyte storage cells, such as nickel-cadmium storage cells or nickel-metal hydride storage cells, or lithium storage cells, such as lithium-ion storage cells. The invention also relates to the method of fabricating the module. The storage cells are preferably lithium-ion storage cells. The invention relates more particularly to cylindrical storage cells but could equally well be applied to elongate storage cells with a square, rectangular or oval cross section.

A plurality of storage cells can be juxtaposed and surrounded by a common protective envelope to form a combination referred to as a module. The modules can in turn be assembled into a battery, in particular for use in an electric vehicle. Various solutions for producing such modules have already been proposed.

2. Description of the Prior Art

The document EP-0 607 675 describes a compact battery which is made up of cylindrical storage cells and incorporates a honeycomb structure to receive the storage cells. The storage cells are sealed and the cells of the honeycomb structure, which is made of a flexible and elastic material, are open at both ends so that cooling can take place by vertical circulation of air coming from the outside between the storage cells. Once placed in the cells of the honeycomb structure, the storage cells are electrically connected in pairs.

The structure proposed in the above document has insufficient mechanical strength to secure and protect the storage cells in a demanding mechanical environment. In addition, the fabrication of the above kind of battery includes numerous operations, in particular for electrically connecting the storage cells.

The document JP-11 001 126 describes a battery including modules made up of a plurality of cylindrical storage cells. Each module has a structure made up of two shells pressed together to form octagonal cross section cells closed at each end by a common cap. One cap incorporates orifices for cooling by circulation of air from the outside. Once placed in the octagonal cells, the storage cells are electrically connected in pairs.

Assembling the structure and electrically connecting the storage cells necessitate numerous operations.

The document FR-2 774 514 describes a module consisting of a plurality of cylindrical storage cells. The terminals of the storage cells are electrically connected by connections connected to an electronic circuit card. The storage cells are juxtaposed in a manner that leaves voids into which one or more electronic circuit cards can be inserted. All of the storage cells are surrounded by a hollow-wall jacket within which a cooling liquid is circulated. Two caps cover the ends of the module.

Electrically connecting the cells to each other and to the electronic circuit card involves a plurality of successive operations that can be complex. In addition, the storage cells are simply inserted in their housing and are not fixed into the housing.

To this end, the present invention proposes a module including a plurality of storage cells combined in an envelope so that the retention and protection of the storage cells in the envelope is at least as good as in the prior art solutions but with improved ease of assembly.

### SUMMARY OF THE INVENTION

The present invention provides a module including at least two storage cells in a common envelope including a bottom including at least two openings with dimensions at least equal to the size of the storage cells and means for fixing the storage cells in the openings, an intermediate body including housings to receive the storage cells, a plate for electrically connecting the storage cells, and a protective cover.

The present invention has many advantages. On the one hand, the mechanical strength of the module is increased because the storage cells are fixed into the openings in the bottom inside their housings. On the other hand, the number of components constituting the envelope is small, and these components are easy and quick to assemble. In particular, the storage cells are electrically connected in a single operation consisting in fitting a plate incorporating all the electrical connections and the electronic components necessary to the operation of the module. Thanks to the invention assembly can be automated. This significantly reduces the time and cost of fabricating the module according to the invention.

The bottom is made of a polymer material. It has openings through it, preferably circular openings, whose inside diameter is close to the outside diameter of the cylindrical storage cells to be placed therein. The storage cells are preferably column-shaped with a circular, square, oval or rectangular cross section, for example. The shape of the openings matches the cross section of the storage cells. In one particular embodiment said fixing means include a strap and means for clamping said strap and said clamping means preferably include at least one spacer fixed to the bottom and at least one screw.

The intermediate body is conveniently formed of two polymer material shells which are assembled into a single component before inserting the storage cells. Said intermediate body advantageously includes means for regulating the temperature of said storage cells. In a first embodiment, said temperature regulator means circulate a cooling fluid within a closed space in the intermediate body. The cooling fluid can be circulated in a reserved space between the storage cells or in the double wall constituting the external envelope of the group of storage cells, for example in a manner similar to that described in the document FR-2 761 203. In a different embodiment, said temperature regulator means circulate a flow of air between the storage cells within said intermediate body.

The polymer material connecting plate is adapted to ensure electrical continuity between the electrodes contained in the storage cells and an external device. The plate carries electronic contacts which are connected to the positive and negative terminals on the top face of the storage cells. Electronic circuit cards for controlling operating parameters of the module are inserted into this plate. A polymer cover protects the plate and provides passages for the connecting means.

The invention also provides a method of fabricating the module described above, including the following steps:

assembling the intermediate body to the bottom,

inserting the storage cells simultaneously into the housings and into the openings,

fixing the storage cells in the openings with the fixing means,

placing the connection plate on the intermediate body in electrical contact with the storage cells,

inserting electronic circuit cards in the plate, and

covering the plate with the cover.

The intermediate body, possibly consisting of two combined shells and incorporating cooling means, is placed on the bottom. The two parts are fastened together, for example using clips and/or plastics material pins that are heated and flattened. The storage cells are then threaded into the housings intended for them and secured in the openings, for example by tightening the strap using screws. After checking that the storage cells are all at the same height, the electrical connection plate is placed on top of the storage cells to electrically interconnect them via their terminals and to establish the electrical connection between the storage cells constituting the module and an external load to be supplied with power or a charger. Electronic circuit cards for monitoring and controlling the operation of the module are inserted into the plate. The function of these cards is to monitor changes in critical operating parameters and to signal any drift therein or possibly to instigate corrective action. A cover is placed over the plate to protect the electronic components. The cover is advantageously equipped with connectors to provide the electrical connection between the connecting plate and the outside environment.

The invention will be better understood and its other advantages and features will become apparent after reading the following description, which is given by way of non-limiting example and accompanied by the appended drawings.

### BRIEF DESCRIPTION OF THE DRAWINGS

FIG. 1 shows one embodiment of a bottom conforming to the invention.

FIG. 2 is a sectional view of an intermediate body conforming to the invention.

FIG. 3 shows the intermediate body in place on the bottom.

FIG. 4 is a top perspective view of a connection plate in place on the intermediate body.

FIG. 5 shows one embodiment of an envelope conforming to the invention fitted with a protective cover.

### DETAILED DESCRIPTION OF THE PREFERRED EMBODIMENT

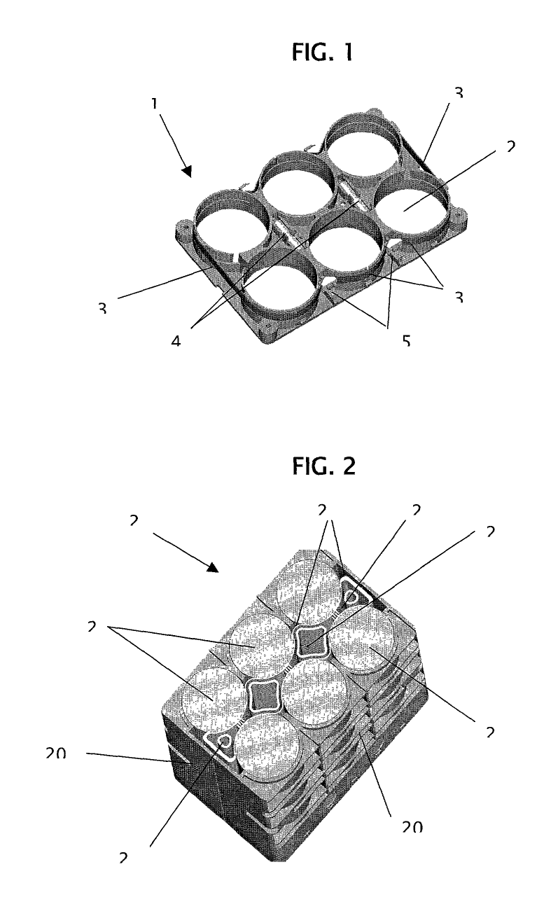

FIG. 1 shows a module bottom 1 conforming to the invention and made of a polymer material, for example a polyamide. The bottom 1 has six circular openings 2 passing through it whose inside diameter is substantially equal to the outside diameter of the cylindrical storage cells that they receive. The bottom 1 includes means for fixing the storage cells in the openings, in the form of a strap 3 and clamping means consisting of two spacers 4 and four screws 5.

The intermediate body 20 shown in FIG. 2 is made from a polymer material, for example a polypropylene. The intermediate body 20 is made up of two shells 20a, 20b which are joined together to form housings 21 for accommodating six storage cells. It includes a cooling system including a wall 22 delimiting a closed space 23 within which a cooling liquid is circulated, for example. A volume limiter 24 for reducing the mass of fluid is placed inside the closed space 23. The limiter 24 is a closed cell polymer member. It confines the fluid close to the wall and thereby limits the volume of cooling fluid used.

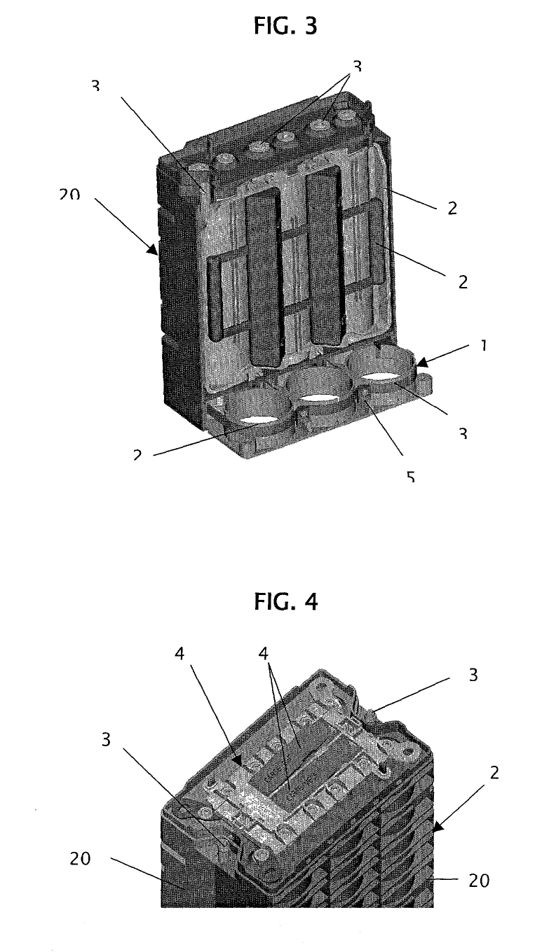

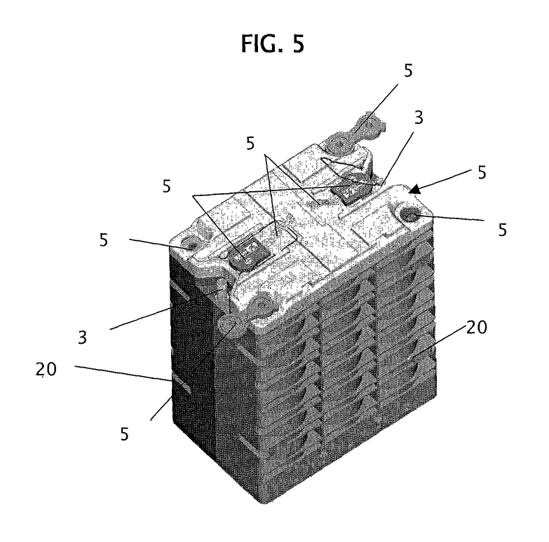

FIG. 3 shows the intermediate body 20 assembled to the bottom 1. For clarity only the shell 20b is shown. The cooling system has cooling liquid inlet/outlet tubes 30. The volume limiter 24 is in position against the wall 21. When the intermediate body 20 and the bottom 1 have been fastened together, cylindrical storage cells are introduced into housings 21 formed in the intermediate body 20 and into the openings 2 in the bottom 1. The storage cells are retained by tensioning the strap 3 by means of the screws 5, which fixes the six storage cells simultaneously to their base. In FIG. 3, three of the six storage cells are in place; their terminals 31 can be seen at the top of the intermediate body 20.

As shown in FIG. 4, an electrical connecting plate 40 is then placed on the terminals 31 and fixed to the storage cells to provide the power and voltage connection. Electronic circuit cards 41 for controlling the module are inserted in the plate 40.

Finally, a cover 50 is fixed by clips on top of the plate 40 to close off and seal the power/electronics area. The cover 50 exposes four terminals 51, namely two positive terminals and two negative terminals, for electrically interconnecting the modules. Two of them carry connecting strips 52. Connectors 53 from which emerge a ribbon made up of conductive wires 54 provide the connection to devices for monitoring and controlling the battery.

There is claimed:

1. A module including at least two storage cells in a common envelope including a bottom including at least two openings with dimensions at least equal to the size of said storage cells and means for fixing said storage cells in said openings, an intermediate body including housings to receive said storage cells, a plate for electrically connecting said storage cells, and a protective cover.

2. The module claimed in claim 1 wherein said fixing means include a strap and means for clamping said strap.

3. The module claimed in claim 1 wherein said clamping means include at least one spacer and at least one screw.

4. The module claimed in claim 1 wherein said intermediate body includes temperature regulator means for regulating the temperature of said storage cells.

5. The module claimed in claim 4 wherein said temperature regulator means circulate a cooling fluid inside a closed space.

6. A method of fabricating a module including at least two storage cells in a common envelope including a bottom including at least two openings with dimensions at least equal to the size of said storage cells and means for fixing said storage cells in said openings, an intermediate body including housings to receive said storage cells, a plate for electrically connecting said storage cells, and a protective cover, said method including the following steps:
assembling said intermediate body to said bottom,
inserting said storage cells simultaneously into said housings and into said openings,
fixing said storage cells in said openings with said fixing means,
placing said connection plate on said intermediate body in electrical contact with said storage cells,
inserting electronic circuit cards in said plate, and
covering said plate with said cover.
